(19) United States
(12) Patent Application Publication
(10) Pub. No.: US 2026/0128026 A1
(43) Pub. Date: May 7, 2026

(54) ACOUSTIC BARRIER METHOD AND SYSTEM

(71) Applicant: SYSTÈMES DE CONTRÔLE ACTIF SOFT DB INC., Québec (CA)

(72) Inventors: William LALIBERTÉ, Québec (CA); Nicolas VERONNEAU, Saint-Jean-sur-Richelieu (CA); Michel PEARSON, Québec (CA)

(21) Appl. No.: 19/381,734

(22) Filed: Nov. 6, 2025

Related U.S. Application Data
(60) Provisional application No. 63/716,778, filed on Nov. 6, 2024.

(51) Int. Cl. G10K 11/162; F16M 11/00

(52) U.S. Cl. CPC G10K 11/162; F16M 11/00

(57) ABSTRACT

A sound attenuation system, method, blanket and kit, reducing noise breakout from a source of noise to a target environment at a distance from the source of noise, the system comprising acoustic blankets comprising an external material selected for resistance to operating conditions, encasing a sound absorbent material, with sealing strips on at least part of a circumferential edge thereof; the sound absorbent material being selected to minimize noise reflection on surfaces of the blankets exposed to the source of noise; the sealing strips sealing gaps between adjacent blankets; at least one of brackets and straps being used to removingly secure the blanket to a frame.

### CROSS REFERENCE TO RELATED APPLICATIONS

This application claims benefit of U.S. provisional application Ser. No. 63/716,778, filed on Nov. 6, 2024. All documents above are incorporated herein in their entirety by reference.

### FIELD OF THE INVENTION

The present invention relates to sound attenuation systems. More specifically, the present invention is concerned with an acoustic barrier method and system.

### BACKGROUND OF THE INVENTION

As construction site screens are increasingly required due to noise management programs or governmental noise regulations, few alternative to barriers made of disposable plywood with rock wool are available. Existing sound attenuation systems suffer from performance issues and/or from a poor design.

There is still a need in the art for acoustic barrier methods and systems.

### SUMMARY OF THE INVENTION

More specifically, in accordance with the present invention, there is provided a sound attenuation system reducing noise breakout from a source of noise to a target environment at a distance from the source of noise, comprising at least one acoustic blanket; wherein each blanket comprises an external material selected for resistance to operating conditions, encasing a sound absorbent material, with sealing strips on at least part of a circumferential edge thereof; the sound absorbent material being selected to minimize noise reflection on surfaces of the blanket exposed to the source of noise; the sealing strips sealing gaps between adjacent blankets; at least one of brackets and straps being used to removingly secure the blanket to a frame.

There is further provided a sound attenuation method for reducing noise breakout from a source of noise to a target environment at a distance from the source of noise, comprising providing a frame on one of a ground surface, a support and a foundation, between the source of noise and the target environment; providing at least one acoustic blanket; each blanket comprising an external material selected for resistance to operating conditions, encasing a sound absorbent material, with sealing strips on at least part of a circumferential edge thereof; the sound absorbent material being selected to minimize noise reflection on surfaces of the blanket exposed to the source of noise; and securing the at least one blanket to the frame, overlapping adjacent ones of the sealing strips.

There is further provided an acoustic blanket, comprising an external material selected for resistance to operating conditions, encasing a sound absorbent material, with sealing strips on at least part of a circumferential edge thereof; the sound absorbent material being selected to minimize noise reflection on surfaces of the blanket exposed to a source of noise; the blanket being configured to be removingly secured to a frame, with adjacent ones of the sealing strips overlapping.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 shows a back view of an assembly according to an embodiment of an aspect of the present disclosure;

FIG. 2A shows a back view of an assembly, facing an environment, opposite a source of noise, according to an embodiment of an aspect of the present disclosure;

FIG. 2B shows the front view of the assembly of FIG. 2A, facing the source of noise;

FIG. 3 is a side perspective view of the assembly of FIG. 1, showing the front view thereof;

FIG. 4 shows details of an assembly according to an embodiment of an aspect of the present disclosure;

FIG. 5 is a close up view of FIG. 2A;

FIG. 6A shows details of a structural frame according to an embodiment of an aspect of the present disclosure;

FIG. 6B is a first close up view of FIG. 6A;

FIG. 6C is a second close up view of FIG. 6A;

FIG. 6D shows a detail of anchoring of a system according to an embodiment of an aspect of the present disclosure;

FIG. 7 shows details of a frame of a system according to an embodiment of an aspect of the present disclosure; and

FIG. 8 is a section of a blanket according to an embodiment of an aspect of the present disclosure.

### DESCRIPTION OF THE INVENTION

The present invention is illustrated in further detail by the following non-limiting examples.

A blanket according to an embodiment of an aspect of the present disclosure generally comprises an outer shell encasing an internal sound absorbent material.

The outer shell is made in a material selected for resistance to the surrounding environment, both on a side thereof exposed to the source of noise, and on the side thereof directed to a target environment to be shielded from the noise. The material of the shell may further be selected based on its compatibility with welding, such as high-frequency (HF) welding for example, in such a way that it may be welded both to itself and to materials used for sealing strips, discussed hereinbelow. In an embodiment of an aspect of the present disclosure, the material selected for the shell is formed into the shell by bonding the material to itself by high-frequency (HF) welding, and bonded to HF weldable sealing strips. Such materials and bonding selection ensure a sealed, durable, and environmentally resistant shell. Moreover, the selection of HF-compatible materials allows simultaneous welding the outer shell and the sealing strips, thereby optimizing manufacturing efficiency as well as ensuring a high-integrity bond in absence of adhesives or mechanical fasteners.

The sound absorbent material is selected to minimize noise reflection on the surface of the blanket exposed to the source of noise. A high density and high noise reduction coefficient (NRC) material, with NRC in a range between 0.4 and 1 for example, may be selected. The high noise reduction coefficient (NRC) quantifies the material's ability to absorb incident sound energy, and high density increases the overall mass of the blanket, thereby enhancing its acoustic performance in terms of transmission loss (TL) and sound transmission class (STC). These parameters are determined by measuring the transmission loss (TL) of a partition across a range of frequencies to evaluate its effectiveness in blocking airborne sound. A higher sound transmission class (STC) value indicates greater resistance to sound transmission and, consequently, improved sound insulation performance. For example, a typical sound-blocking vinyl is characterized by a sound transmission class (STC) rating of about 25.

In an embodiment of an aspect of the present disclosure, the outer shell comprises a polyvinyl chloride (PVC) fabric or a fiberglass-reinforced PVC fabric, selected for weldability to itself and to a weld-compatible hook-and-loop fastening material, of a density of about 0.11 kg/m². The sound absorbent material comprises at least one layer of rock wool, fiberglass wool, melamine foam, polyester wool, or similar materials, having a density of about 4.00 kg/m². Layers may further be selected to stop vibrations, in butyl rubber for example, and/or to block airborne noise, such as in a mass-loaded vinyl or another non-metallic material having a density of at least 5 kg/m², to achieve a target minimum blanket density in a range between about 10 kg/m² and about 15 kg/m², for example of about 10 kg/m². The materials, densities, number and thicknesses of layers of the sound absorbent materials within the shell are selected to achieve a target minimum blanket density in view of a target acoustic performance, according to the source of noise and the targeted level of sound reduction in the environment to be shielded from the noise.

In an embodiment schematized in FIG. 8, for example, the blanket B comprises a shell 10 of UV-resistant, heat-resistant, and waterproof fiberglass-reinforced PVC fabric, of a density of 0.11 kg/m², a high density (4.00 kg/m²) 50 mm-thick rock wool layer 12, and a high density (density of 8.85 kg/m²) sound blocking vinyl layer 16, for a total density of about 13.07 kg/m², selected to absorb and block the noise between the source of noise and the environment to be shielded from the noise. The outer PVC fabric, on both sides of the blanket, is selected for acoustic transparency, allowing the absorbent materials to be exposed to the incoming noise and thus limiting sound reflections on the side of the blanket exposed to the source of noise.

Other materials for the shell, sound absorbent materials and bonding methods may be contemplated.

In embodiments of the present disclosure, the outer shell comprises fiberglass-reinforced PVC fabric selected specifically for compatibility with high-frequency (HF) welding and high-frequency (HF) weldable sealing strips. Unlike conventional textile-based bonding methods using stitching, adhesives, or mechanical fasteners, high-frequency (HF) welding enables material-to-material welding to form the outer shell without perforation or chemical bonding agents. Since the material of the outer shell is weldable to itself and to a hook-and-loop fastening material that is selected for HF welding compatibility, integral attachment points and closures are formed without sewing or adhesive lamination. Such welding method produces continuous, sealed seams that maintain the environmental resistance and structural integrity of the outer shell. HF welding allows optimized tear resistance at seam locations compared to stitched or adhesive joints, and prevents moisture ingress, particulate shedding, and degradation of bond strength over time. Thus, the welded seams maintain long-term durability under mechanical vibration, exposure to the operating conditions, and repeated installation cycles in industrial applications for example. Additionally, as HF welding enables simultaneous joining of multiple layers, such as the PVC fabric and the hook-and-loop fastening materials, manufacturing efficiency and uniformity of seam quality are optimised.

The sound absorbent layers may be bonded to each other and to the material of the shell. They may be sewn to an intermediate layer of the material of the shell, which may then be welded to the shell. Mechanical fasteners may also be used to secure the sound absorbent layers to the intermediate layer if needed.

Such selective assembly results in a sealed, rugged, and reusable blanket, of enhanced acoustic performance and manufacturability compared to sewn or adhesively bonded alternatives.

Assemblies using sewing, adhesive bonding, mechanical fastening, or a combination thereof, may still be alternatives to welding the outer material into an outer shell and to the sealing strips.

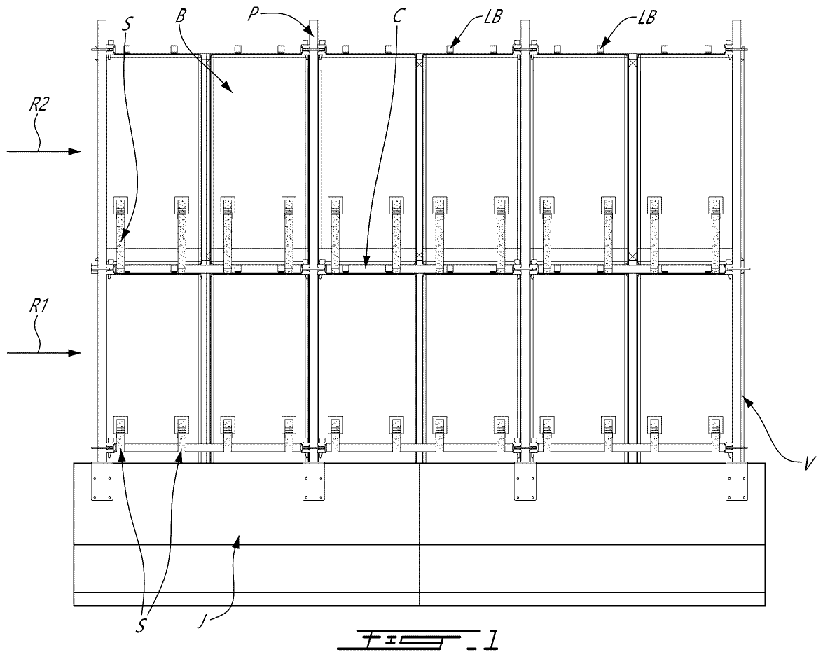

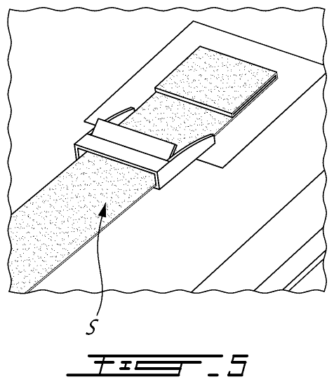

As discussed hereinbelow in relation to FIGS. 1-7 for example, the blankets B are supported by a frame comprising poles P and cross beams C, in galvanized steel or aluminum for example. Braces O, in galvanized steel or aluminum for example, may be used for reinforcement, against wind load for example. Other materials may be used, including wood for example.

Each blanket comprise a sealing strip (V) on at least part of an outer circumference thereof. In an assembly of blankets, the sealing strips of adjacent blankets overlap, thereby sealing gaps between the adjacent blankets and thus preventing acoustic leaks between the adjacent blankets of the assembly. The sealing strips (V) may be hook and loop fastener strips, such as Velcro™ strips for example; heavy, dense, or thick materials may be used, in view of high mass for a target sound transmission loss; a high mass material, for example of about 5 kg/m², for example, may be used, or an open cell foam or strips of magnetic tapes or adhesive tapes, for a typical sound transmission class (STC) rating STC 25.

The materials of the blanket are thus selected and combined in view of target sound transmission loss and target resistance to operating conditions in the environment, such as water tightness or resistance to UV for example, in such a way that the sound from the source of noise reaches the sound absorbent material and is blocked thereby. Welding to form the outer shell ensures that the blanket is liquid proof.

The blanket B may be positioned relative to the frame using brackets LB and straps S (see FIGS. 1, 2, 6 for example). The blanket B may comprise eyelets E (FIG. 8) on at least part of the circumference thereof, for attachment to the frame using cable ties for example (not shown).

FIG. 1 illustrates the side of an acoustic attenuation system according to an embodiment of the present disclosure oriented toward a source of noise. The system includes rows R1 and R2 of acoustic blankets B supported by a structural frame. The frame may be anchored directly to the ground or mounted on a support, such as concrete jersey barriers (J). Each blanket B is secured to cross beams C of the frame. In the illustrated embodiment, each blanket is suspended to a top cross beam C by metal brackets (LB), and secured at its lower edge to a bottom cross beam by self-locking straps(S) that wrap around the cross beam, the straps wrapping around the cross beam C. (see FIGS. 1, 2, 6 for example), thereby securing the blanket in place.

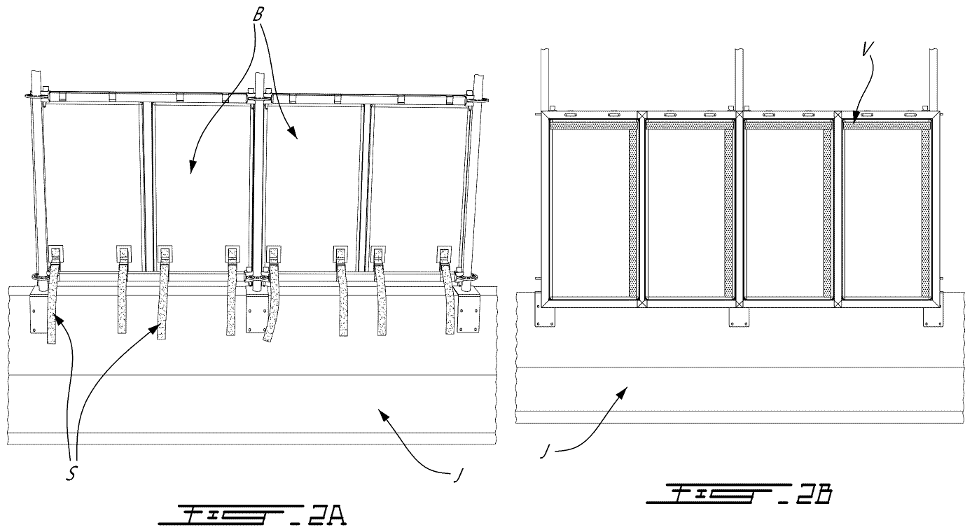

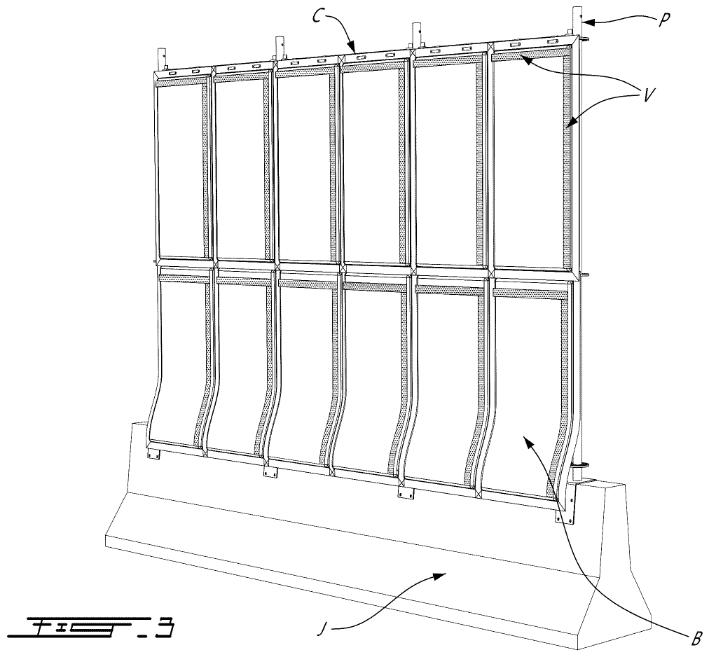

FIG. 2A shows the side of an acoustic attenuation system according to an embodiment of the present disclosure facing a source of noise to be blocked. The system comprises one row of blankets B supported by concrete Jersey barriers J using straps S. FIG. 2B shows the opposite side of the same system, which faces the environment to be shielded from the source of noise.

FIG. 3 shows the side of the system of FIG. 1 facing the environment to be shielded from the source of noise.

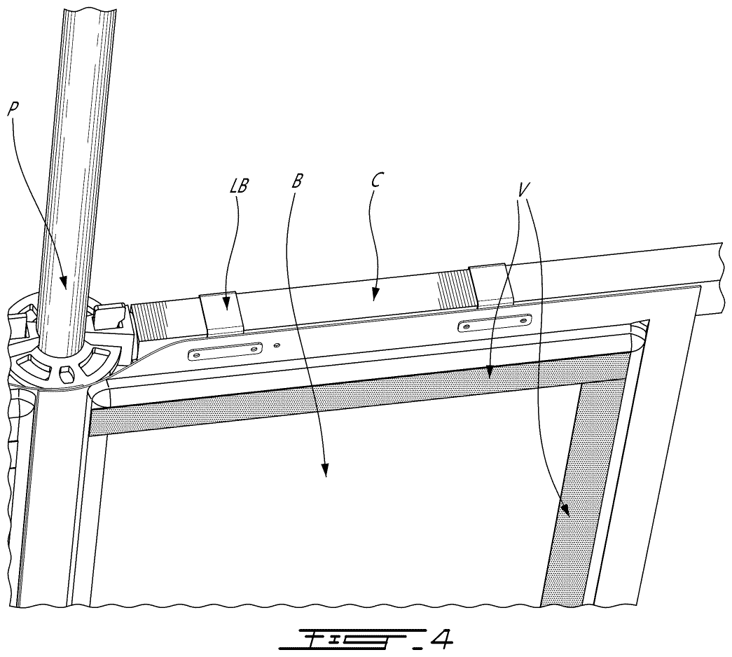

According to an embodiment of an aspect of the present disclosure, brackets are used to removingly suspend the blanket to a top cross beam C of the frame. FIG. 4 for example shows brackets LB of a square shape selected to engage with the top cross beam C of a matching cross section; as seen in FIG. 1, straps S are used to secure the lower edge of the blanket relative to a bottom cross beam C. The combination of cross beams and brackets with selected cross sections allows precise and stable positioning of the blankets relative to the frame, thereby preventing acoustic leaks therebetween. The straps S may be self-locking straps, as shown in FIGS. 1, 2A and 5 for example.

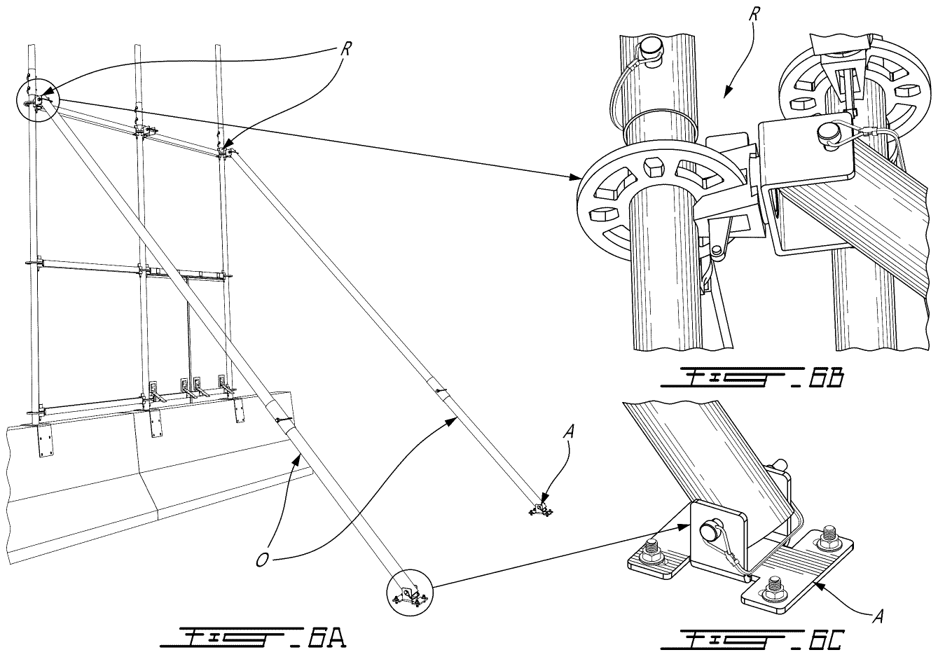

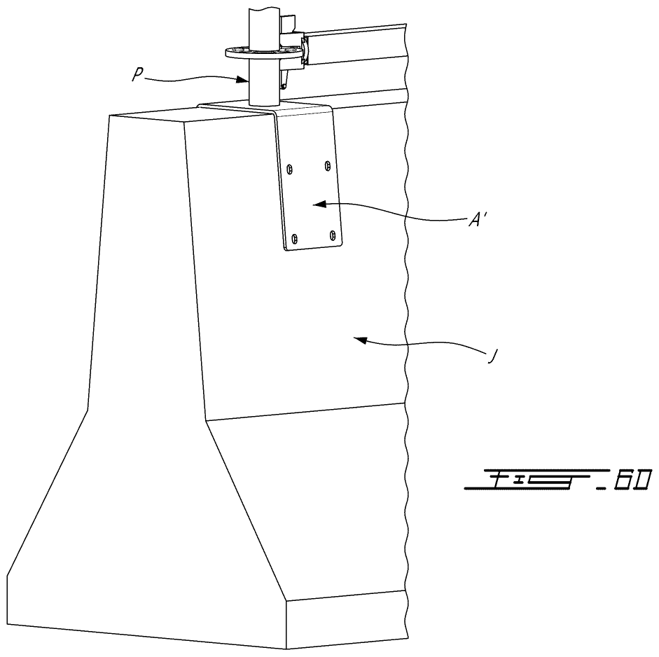

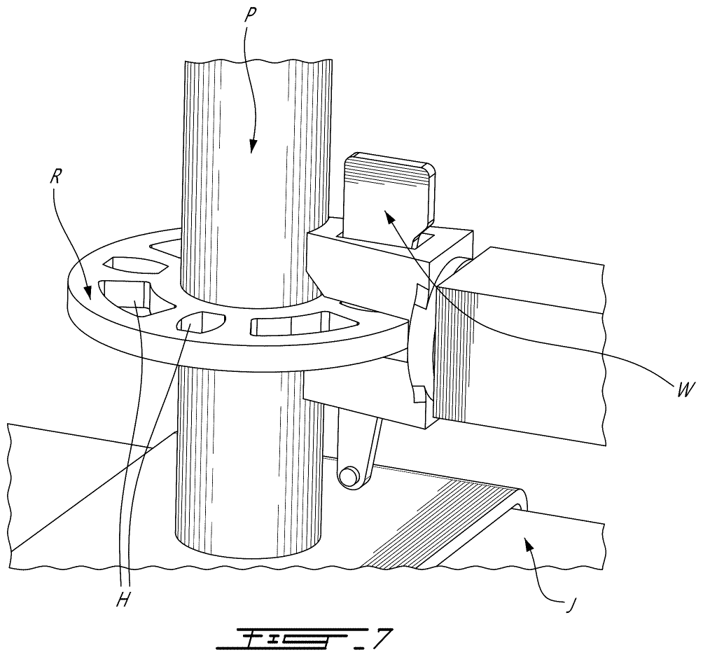

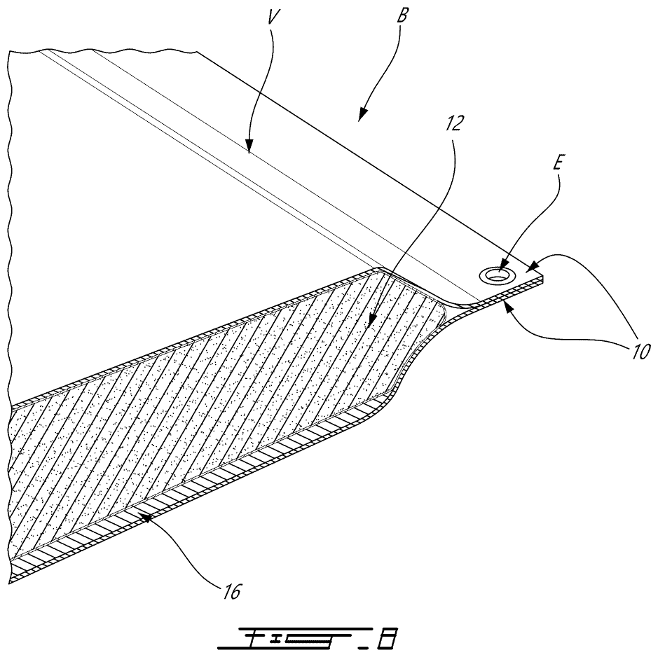

Standard equipment, such as modular, ring-lock scaffolding, may be used to erect the modular sound acoustic attenuation systems of the present disclosure. The spacings between the poles P and between the cross beams C are selected in relation to the sizes of the blankets B; the cross beams may be secured to the poles using fasteners, such as such as ring-lock systems for example. The structural frame may be supported by the ground, or by concrete Jersey J for example as shown in FIGS. 1 and 3 for example, using anchors. The anchors may be screwed plates A (see FIG. 6C), or mounting ring/jaw/wedge fasteners (see FIG. 7). Similarly, adjustable bracings O may be fixed to the ground or the concrete support using anchors, such as plates A screwed into the ground for example (FIG. 6A, FIG. 6C) or to the concrete support, mounting ring R, such as ring lock type, i.e. a ring with concentric holes H used to receive a jaw and a metal wedge W, used to secure the upper end of the bracings O to the frame. FIG. 6D shows a detail of an anchor plate A′ welded to a pole P and fixed to a concrete block J.

The blankets may be assembled to the frame using the brackets LB and straps S (see LB FIG. 4 for example), in a range of configurations, and may be readily disassembled if needed.

FIG. 7 shows a pole P welded to a metallic plate screwed to a concrete Jersey J. Mounting rings R, welded to the pole P, and ring locks systems with jaws and metal wedges W may be used to connect the cross beams to the poles of the frame together.

A method according to an embodiment of an aspect of the present disclosure generally comprises positioning and securing poles on concrete blocks or on the ground, using anchors for example (see FIG. 7 for example), and securing cross beams C on the poles P (FIG. 4) using fasteners such as hooks or ring-lock systems R (see FIG. 6B) for example. Bracings O may further be attached, using fasteners such as hooks or ring-lock systems R (see for example FIGS. 6A-6C) for example between the pole and the concrete block or directly to the ground. Alternatively, the frame may be provided with a foundation. The blankets are positioned in relation to the poles and cross beams so that the sealing strips of adjacent blankets overlap.

There is thus provided a temporary or permanent sound attenuation system to prevent noise originating from industrial activities or construction sites from reaching target environment such as residences or other sensitive locations at a distance from the source of noise. The presently disclosed acoustic sound attenuation system and method provide a reusable solution in case of operations or activities where noise limitations are imposed or desirable. The blankets may be readily mounted to a pre-existing structural frame, such as a fencing for example, or to a structural frame as disclosed herein for example, and dismounted therefrom. The presently disclosed acoustic blankets may be reused, either on existing frames or on a structural frame as disclosed herein.

The presently disclosed combination of blankets, brackets, quick couplers, such as ring-lock system R illustrated hereinabove, with self-locking strap and hooks and anchors, allows effective, robust, portable, reusable, and rapidly installed and dismounted sound attenuation systems.

The sound attenuation system may be tailored according to the dimensions of the source of noise such as machinery or equipment or entire sites, in a segmented, modular, sound attenuation system. The blankets may be arranged in adjacent stacked rows, into complete or part sound attenuation systems according to specific sites and needs. Blankets may be rapidly dismounted, in case the sound attenuation system is positioned in close proximity to equipment which requires access, for periodic servicing for example. The blankets may be selected to be resistant to exposure to a range of operating conditions, such as temperatures, UV, oils or other products.

There is thus presented a sound attenuation system kit, comprising acoustic blankets, poles and cross beams, fasteners, anchors and brackets; each blanket comprises a sound absorbent material protected in a shell with sealing strips on at least part of a circumference thereof; the poles are configured to be removingly secured to a support using the anchors and the cross beams and the poles are configured to be removably connected together using the fasteners and to removably support an assembly of the blankets using the brackets, into a sound attenuation system, the sealing strips of adjacent blankets in the sound attenuation system overlapping; the sound absorbent material is selected to prevent noise reflection on surfaces of the sound attenuation system exposed to the source of noise.

The presently disclosed frame may be self-supporting, in absence of a separate anchoring foundation, anchors or permanent foundations. The sound attenuation system may be a screen, or a part or a full sided enclosure, including roof side thereof if needed.

In experiments, a sound attenuation screen of 3.3 m height of 2 rows of blankets, supported on a concrete block, positioned in relation to typical construction site with equipment such as compressors/generator/trucks, the length of the screen about 1.4 times the length of the construction site, was tested; the noise reduction from the construction site to a targeted residential area was between about 10 dB and about 15 dB in the frequency range between about 250 Hz and about 4000 Hz.

As people in the art will be in a position to appreciate, the presently disclosed sound attenuation system may be used to block noise, either permanently or temporarily, from operating sites such as construction sites, industrial sites, mining quarry sites, commercial or institutional sites, for example.

The scope of the claims should not be limited by the illustrated embodiments set forth in the examples, but should be given the broadest interpretation consistent with the description as a whole.

1. A sound attenuation system reducing noise breakout from a source of noise to a target environment at a distance from the source of noise, comprising at least one acoustic blanket; wherein each blanket comprises an external material selected for resistance to operating conditions, encasing a sound absorbent material, with sealing strips on at least part of a circumferential edge thereof; the sound absorbent material being selected to minimize noise reflection on surfaces of the blanket exposed to the source of noise; the sealing strips sealing gaps between adjacent blankets; at least one of brackets and straps being used to removingly secure the blanket to a frame.

2. The sound attenuation system of claim 1, wherein the external material is one of a reinforced polyvinyl chloride (PVC) fabric and a fiberglass-reinforced PVC fabric selected for weldability to itself into an outer shell, and to the sealing strips, the outer shell having a density of 0.11 kg/m²; and the sound absorbent material comprises at least one of rock wool, fiberglass wool, melamine foam, and polyester wool, of a density of 4.00 kg/m², and a mass layer comprising one of butyl rubber, mass-loaded vinyl, and a non-metallic acoustic mass material having a density of at least approximately 5 kg/m²,
wherein a combination of the outer shell and the sound absorbent material is selected in view of a total blanket density of at least 10 kg/m², according to the source of noise and a targeted sound reduction.

3. The sound attenuation system of claim 1, wherein the external material is one of a PVC and a fiberglass-reinforced PVC, and the sound absorbent material comprises one of rock wool, fiberglass wool, melamine foam, and polyester wool; the blanket further comprising one of: butyl rubber, mass loaded vinyl and a non-metallic material, selected in view of a minimum density for the blanket as a whole of 10 kg/m², depending on the source of noise and of a targeted sound reduction.

4. The sound attenuation system of claim 1, wherein the external material is shaped into forms a shell and is bonded to the sealing strips, by high frequency welding.

5. The sound attenuation system of claim 1, wherein the external material is selected for acoustic transparency.

6. The sound attenuation system of claim 1, wherein the frame comprises poles and cross beams supporting the at least one blanket.

7. The sound attenuation system of claim 1, wherein the frame is made in one of galvanized steel and aluminum.

8. The sound attenuation system of claim 1, wherein the frame comprises poles and cross beams supporting the at least one blanket.

9. The sound attenuation system of claim 1, wherein the at least one blanket comprises eyelets, for attachment to the frame using ties.

10. The sound attenuation system of claim 1, wherein the sealing strips are ones of hook and loop fastener strips, open cell foam strips, strips of magnetic tapes and strips of adhesive tapes.

11. The sound attenuation system of claim 1, wherein the sealing strips are in a material of a sound transmission class rating STC 25.

12. The sound attenuation system of claim 1, wherein the at least one blanket is secured to cross beams of the frame using the at least one of brackets and straps.

13. The sound attenuation system of claim 1, wherein the frame is supported by one of the ground, concrete blocks and a foundation.

14. A sound attenuation method for reducing noise breakout from a source of noise to a target environment at a distance from the source of noise, comprising:
providing a frame on one of a ground surface, a support and a foundation, between the source of noise and the target environment;
providing at least one acoustic blanket; each blanket comprising an external material selected for resistance to operating conditions, encasing a sound absorbent material, with sealing strips on at least part of a circumferential edge thereof; the sound absorbent material being selected to minimize noise reflection on surfaces of the blanket exposed to the source of noise; and
securing the at least one blanket to the frame, overlapping adjacent ones of the sealing strips.

15. The method of claim 14, wherein the frame comprises poles and cross beams; a top edge of the at least one blanket being fastened to a top cross beam of the frame by brackets, and a lower edge of the at least one blanket being secured to a bottom cross beam of the frame by straps.

16. An acoustic blanket, comprising an external material selected for resistance to operating conditions, encasing a sound absorbent material, with sealing strips on at least part of a circumferential edge thereof; the sound absorbent material being selected to minimize noise reflection on surfaces of the blanket exposed to a source of noise; the blanket being configured to be removingly secured to a frame, with adjacent ones of the sealing strips overlapping.

17. The blanket of claim 16, wherein the external material is one of a PVC and a fiberglass-reinforced PVC, and the sound absorbent material comprises at least one of rock wool, fiberglass wool, melamine foam, and polyester wool.

18. The blanket of claim 16, wherein the external material is one of a PVC and a fiberglass fabric, and the sound absorbent material comprises at least one of rock wool, fiberglass wool, melamine foam, and polyester wool, the blanket further comprising one of: butyl rubber, mass loaded vinyl and a non-metallic material, in view of a minimum density for the blanket as a whole of 10 kg/m², depending on the source of noise and of a targeted sound attenuation.

19. The sound attenuation system of claim 16, wherein the blanket comprises UV resistant heat and waterproof fiberglass-reinforced PVC, rock wool, and sound-blocking vinyl, for a total density of at least 10 kg/m², depending on the source of noise and of a targeted sound attenuation.

20. A sound attenuation system kit, comprising at least one blanket according to claim 16 and the frame, the blanket configured to be removingly mounted to the frame using at least ones of brackets and straps, to form sound attenuation system between the source of noise and a target environment, the sealing strips overlapping between adjacent blankets in the sound attenuation system.
